(19) United States
(12) Patent Application Publication
(10) Pub. No.: US 2012/0158819 A1
(43) Pub. Date: Jun. 21, 2012

(54) POLICY-BASED APPLICATION DELIVERY

(75) Inventors: Angela Mele Anderson, Boston, MA (US); Charles Kekeh, Melrose, MA (US); Scott Elliot Stearns, Ludlow, VT (US); Kristofer Hellick Reierson, Acton, MA (US); Lidiane Pereira de Souza, Middleton, MA (US)

(73) Assignee: MICROSOFT CORPORATION, Redmond, WA (US)

(21) Appl. No.: 12/973,905

(22) Filed: Dec. 21, 2010

(51) Int. Cl. G06F 15/16

(52) U.S. Cl. 709/202; 709/203

(57) ABSTRACT

Technologies are described herein for automatically selecting a best application delivery method based on a centrally maintained policy. An agent executing on a user computing device receives a request to initiate an application. The agent requests a centrally maintained application placement policy document regarding the application program from a policy server. The application placement policy document may describe a policy for determining a method for delivery of the application to the user computing device based on a number of conditions. The agent selects the method for delivery of the application based on the application placement policy document and the current conditions, and then initiates the application program utilizing the selected application delivery method.

### BACKGROUND

Desktop virtualization allows software applications executed by a user of a computing device to be decoupled from the hardware, operating system (“OS”), and local configuration of the user's computing device. A number of methods of delivering remote applications to the user's computing device may be available, each with specific capabilities, advantages, and disadvantages. For example, application virtualization allows an application to be deployed to the user computing device over a network connection from virtualized application packages maintained on a virtual application server.

Application virtualization may remove the requirement for an application to be installed, configured, and maintained locally on the user computing device. Instead, a virtual application runtime may execute on the computer and stream the application components from the virtualized application package on the server. In addition, the application components may be cached locally on the user computing device, allowing the application to be executed by the user even when no network connection exists. However, if the application is not cached or the components of the application frequently change, excessive amounts of network bandwidth may be required to deploy the application. Moreover, the application executes locally on the user computing device, potentially requiring sufficient local processing resources as well as network connections to other systems supplying data to the application.

Session virtualization allows a user to execute an application remotely on a remote server, such as a remote desktop services (“RDS”) server. No local installation or deployment of the application components to the user computing device is necessary. Instead a “thin client” application executes locally on the user computing device that extends the user interface of the application executing on the RDS server to the user computing device. Because the application executes on a remote server, all or nearly all of the application components and connections to data sources exist on the remote server. However, applications having a graphically intensive user interface may not perform well in a virtual session, and a constant network connection between the user computing device and the RDS server may be required in order for the user to execute the application on the remote server.

Virtual desktop infrastructure (“VDI”) extends the concept of thin client access to applications even further, allocating a single instance of an operating system and application environment to the user connecting from the user computing device over the thin client. VDI allows the installation and configuration of the user's applications and environment to be maintained centrally, as well as isolates the execution of the user's applications from other users operating in other operating system instances. Like session virtualization, however, VDI requires a full-time network connection in order for the user of the user computing device to execute and interact with the applications running in their environment.

In a typical enterprise environment, users may work from a variety of locations and in a variety of conditions, such as from their primary office workstation connected to a local-area network (“LAN”), on a workstation in a branch office, from their laptop over a WI-FI connection, from a home office over residential digital subscriber line (“DSL”), from their wireless phone while on the road, or the like. The best method for delivering a particular application to the user's computing device may vary across these situations. For example, the application delivery method for a user working from home may be to utilize VDI to optimize the user's experience. However, when the user is working from the office, streaming of the application directly to the user's workstation may be the best method.

The best method may be based on a number of conditions, such as network bandwidth available, capabilities of the user computing device, the identity of the user, the nature and/or criticality of the application, the security of the network connection, and the like. However, the user may be unaware of the specific capabilities, advantages, and disadvantages of each of the application delivery methods. The user may manually select the perceived best application delivery method, or just simply execute the application using the default method. This may result in failed or partial delivery of the application, or a poor end-user experience because the application is not available.

It is with respect to these considerations and others that the disclosure made herein; is presented.

### SUMMARY

Technologies are described herein for automatically selecting a best application delivery method based on a centrally maintained policy. Utilizing the described technologies, administrator personnel may create and maintain a central policy for the delivery of an application to end-user computing devices based on performance, security, and connectivity requirements of the application and the various conditions that may exist in the user's environment. When a user initiates the application, the application may be delivered to the user's computing device using an application delivery method determined from the centrally maintained policy based on the current conditions of the user's environment. In this way, a best or optimal method of application delivery will be utilized to deliver applications to the end-user computing device regardless of the environmental conditions and without requiring specific knowledge or action of the user.

According to embodiments, an agent executing on the user's computing device receives a request to initiate an application. The agent requests a centrally maintained application placement policy document regarding the application program from a policy server. The application placement policy document may describe a policy for determining a method for delivery of the application to the user computing device based on a number of conditions. The agent selects the method for delivery of the application based on the application placement policy document and the current conditions, and then initiates the application program utilizing the selected delivery method.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIG. 2 is a flow diagram showing methods for automatically selecting a best application delivery method based on a centrally maintained policy, according to embodiments described herein; and

FIG. 3 is a block diagram showing an illustrative computer hardware and software architecture for a computing system capable of implementing aspects of the embodiments presented herein.

### DETAILED DESCRIPTION

The following detailed description is directed to technologies for automatically selecting a best method for delivering an application to an end-user computing device based on a centrally maintained policy and the current environment of the computing device. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

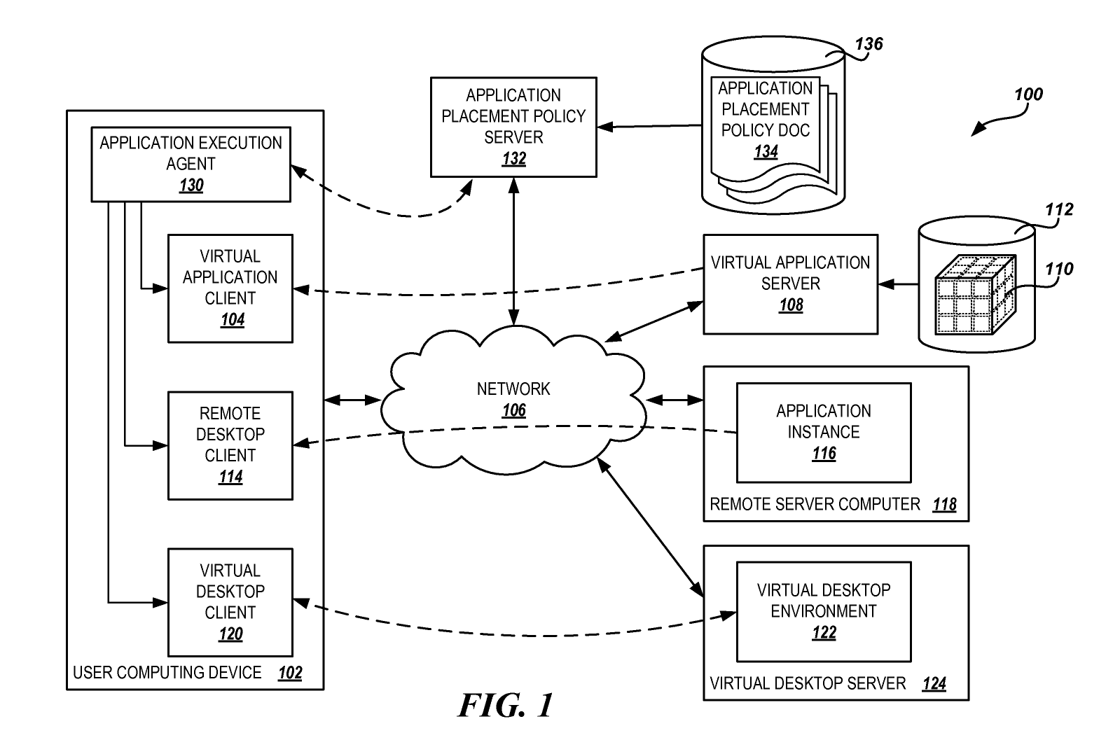

FIG. 1 shows an illustrative operating environment 100 including several software components for automatically selecting a best application delivery method based on a centrally maintained policy, according to embodiments provided herein. The environment 100 includes a user computing device 102. The user computing device 102 may be a personal computer (“PC”), such as a desktop workstation, a laptop, or a notebook; a personal digital assistant (“PDA”); a wireless telephone; a set-lop box; a gaming console; an application server; a Web server hosting Web-based application programs; or any other computing device that can execute application programs for a user.

According to embodiments, the user computing device 102 may be configured with a number of methods for the delivery of remote application programs to the device. Specifically, the user computing device 102 may execute a virtual application client 104. The virtual application client 104 may allow the user computing device 102 to launch and execute an application program that has not been previously installed on the device. The virtual application client 104 may instead stream the components of the application program in real-time or near real-time over a network 106 from a virtual application server 108. The virtual application client 104 and virtual application server 108 may be based upon the MICROSOFT® APP-V technology from MICROSOFT Corporation of Redmond, Wash., the CITRIX XENAPP™ technology from CITRIX SYSTEMS Inc. of Fort Lauderdale, Fla., or any other application streaming and virtualization platform or technologies. The network 106 may be a LAN, a wide-area network (“WAN”), the Internet, or any other networking topology that connects the user computing device 102 to the virtual application server 108.

The components of the application program software may be stored in a virtualized application package 110 located on a storage device 112 accessible by the virtual application server 108. According to embodiments, the virtualized application package 110 consists of a number of blocks of data that contain application program structure information as well as the individual component files and other elements of the application. The virtual application package 110 may be created by an administrator personnel by installing a traditional software application program on a management computer and recording the changes made to local file system and registry reflecting a typical local installation of the application program, for example. The blocks in the virtualized application package 110 are streamed to the virtual application client 104 to allow the application program to be executed on the user computing device 102. In one embodiment, the virtual application client 104 caches the blocks of the virtualized application package 110 in a local cache, such that the application program may be available for execution on the user computing device 102 in the event that no network connection with the virtual application server 108 exists.

The virtual application client 104 may create a separate virtual environment, referred to as an application sandbox, to execute each application program streamed from the virtual application server 108. The application sandbox allows the components of the application program to execute in isolation from the remainder of the system. For example, the application program may execute using its own version of common library files, without a danger of the library files being overwritten by the installation of another software package or an update to the OS of the user computing device 102. In addition, any changes made by the initialization or execution of the application program are further isolated to the application sandbox. If a user of the application program modifies configuration files or registry entries related to the application, these changes may only be reflected in the particular application sandbox in which the program is executing.

The user computing device 102 may further execute a remote desktop client 114. The remote desktop client 114 may allow the user of the user computing device 102 to start and interact across the network 106 with a remotely executing instance of an application program, such as an application instance 116 executing on a remote server computer 118. The remote desktop client 114 may utilize the remote desktop protocol (“RDP”) to communicate with a remote server computer 118 running MICROSOFT® WINDOWS SERVER® operating system, for example. According to one embodiment, the remote desktop client 114 may display the user interface for the application instance 116 executing on the remote server computer 118 in a window on the user computing device 102 in such a manner that the user of the user computing device may not readily distinguish locally executing applications from remotely executing applications.

The remote server computer 118 may initiate separate application instances 116 for each user computing device 102 executing the application program through the remote desktop client 114 from a single application image (not shown) maintained on the server. The application image may be installed and maintained on the remote server computer 118 by administrator personnel in a user-independent fashion, for example. In one embodiment, the remote server computer 118 may stream the application program for each application instance 116 from the virtual application server 108 in the manner described above.

The user computing device 102 may also execute a virtual desktop client 120. The virtual desktop client 120 may be a lightweight client program that presents the user of the user computing device 102 with a virtual desktop environment 122 hosted on a remote virtual desktop server 124 across the network 106. The virtual desktop environment 122 may provide an environment in which the user may initiate and interact with instances of application programs. The application programs may be installed and configured specific to the user in the virtual desktop environment 122. The virtual desktop server 124 may also stream the application program from the virtual application server 108 in the manner described above.

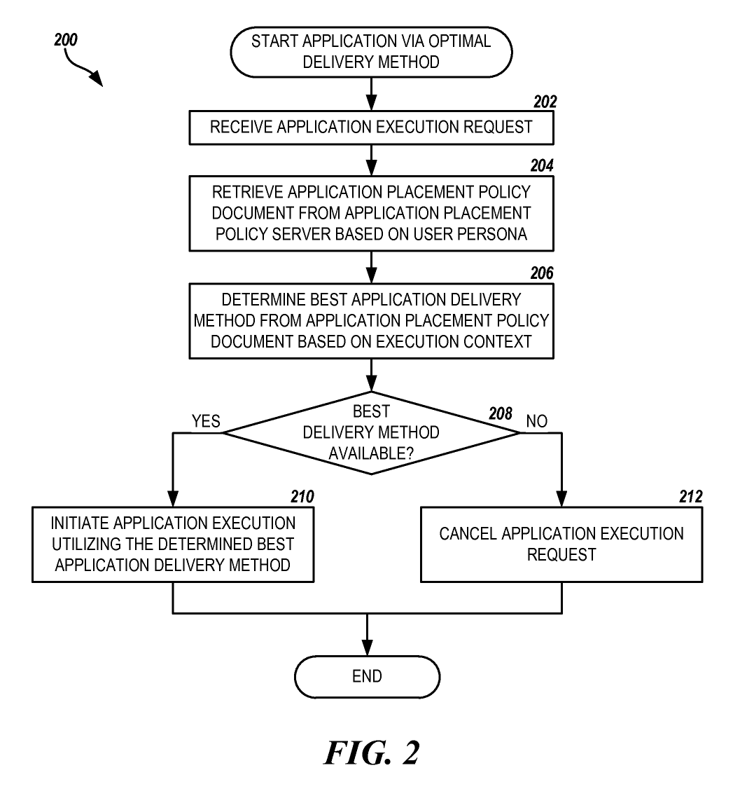

The user computing device 102 may farther include an application execution agent 130. The application execution agent 130 may be a program on the user computing device 102 that receives requests for the execution of a particular application program from a user of the user computing device 102. For example, the application execution agent 130 may be linked to an application shortcut corresponding to the application program on the user's desktop. When the user selects the application shortcut from the desktop, the application execution agent 130 may determine the best method for delivering the requested application program to the user computing device 102 based on the conditions of the current environment and a centrally maintained policy, as will be described in more detail below in regard to FIG. 2.

It order to determine the best method of application delivery to be utilized for the requested application program, the application execution agent 130 may request an application placement policy document 134 regarding the requested application program for the user from an application placement policy server 132 across the network 106. The application placement policy document 134 may describe a policy for the delivery of a specific application program to a user computing device 102 based on a variety of user and/or device conditions. The application placement policy server 132 may maintain a number of application placement policy documents 134 regarding various applications in a datastore 136, such as a database or other storage mechanism accessible to the application placement policy server. The application placement policy documents 134 may be extensible markup language (“XML”) documents containing structured data describing the applicable policies, for example.

The application placement policy documents 134 may be created and centrally maintained by administrator personnel in the datastore 136. For example, one or more application placement policy documents 134 may be created regarding a particular application program when the virtual application package 110 for the application is created by administrator personnel and stored on the virtual application server 104. Upon receiving the request from the application execution agent 130, the application placement policy server 132 may retrieve the application placement policy document 134 for the requested application program describing the policy applicable to the current user of the user computing device 102 from the datastore 136 and return the document to the application execution agent 130. The application execution agent 130 may then determine the best method of delivering the requested application program to the user computing device 102 from the received application placement policy document 134 and the current conditions of the user's environment, as is further described below in regard to FIG. 2.

Upon determining the best method of delivering the requested application program, the application execution agent 130 may initiate execution of the application program through the client configured for the selected method. For example, the application execution agent 130 may initiate the requested application program through the virtual application client 104, the remote desktop client 114, or the virtual desktop client 120 configured on the user computing device 102. According to one embodiment, the application execution agent 130 may initiate execution of the requested application program in such a way that the user of the user computing device 102 is not readily aware of the method of execution selected. Further, the virtual application client 104, the remote desktop client 114, and the virtual desktop client 120 may present the user interface of the executing application program in a consistent fashion to the user of the user computing device 102 such that the application delivery and execution method may not be readily apparent to the user.

Referring now to FIG. 2, additional details will be provided regarding the embodiments presented herein. It should be appreciated that the logical operations described with respect to FIG. 2 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. The operations may also be performed in a different order than described.

FIG. 2 illustrates a routine 200 for automatically selecting a best application delivery method based on a centrally maintained policy, according to embodiments described herein. The routine 200 may be performed by a combination of the application execution agent 130 executing on the user computing device 102 and/or modules executing on the application placement policy server 132. It will be appreciated that the routine 200 may also be performed by other modules or components executing on other computing devices, or by any combination of modules, components, and computing devices.

The routine 200 begins at operation 202, where the application execution agent 130 receives a request to execute an application program from the user of the user computing device 102. For example, as described above in regard to FIG. 1, the user may select an application shortcut corresponding to the desired application program from the user's desktop that is linked to the application execution agent 130. From operation 202, the routine 200 proceeds to operation 204, where the application execution agent 130 requests the application placement policy document 134 regarding the requested application program from the application placement policy server 132. The application placement policy server 132 then retrieves the applicable application placement policy document 134 from the datastore 136, and returns the policy document to the application execution agent 130.

According to one embodiment, the application placement policy server 132 selects the applicable application placement policy document 134 in the datastore 136 based on the requested application program and/or a persona of the current user of the user computing device 102. The persona of a user may include the user's identity, the user's role(s) in the organization, security or administrative group memberships, and the like. For example, administrator personnel may create one policy for delivery of a particular application program for one group of users in a first application placement policy document 134, and another policy of the delivery of the application for a different group of users in a second application placement policy document. This may be the case when the business criticality of the application program is considered different for the different user groups, for example.

The group membership of the current user may be considered by the application placement policy server 132 in selecting the applicable application placement policy document 134 from the datastore 136. It will be appreciated that other aspects of the current user's person may be considered by the application placement policy server 132 in selecting from among the application placement policy documents 134 regarding the requested application program in the datastore 136. In a further embodiment, the different policies regarding delivery of the requested application program for the different user groups may be maintained in a single application placement policy document 134, and the applicable policy may be determined by the application execution agent 130 from the user's persona on the user computing device 102.

The routine 200 then proceeds from operation 204 to operation 206, where the application execution agent 130 determines the best method for delivering the requested application program to the user computing device 102 based on the retrieved application placement policy document 134. As described above in regard to FIG. 1, the application placement policy document 134 describes a policy for the delivery of the requested application program based on a variety of user and/or device contexts. The application placement policy document 134 may specify a number of factors or conditions that are to be considered by the application execution agent 130 in determining the best application delivery method.

In one embodiment, the application placement policy document 134 specifies a number of environmental conditions to be considered, such as a physical location of the user computing device 102 (e.g. in the office, in the user's home, etc.), the network connection currently utilized by the device (e.g. the office LAN, an enterprise WAN, connected via the VPN, connected over the Internet, etc.), security of the network connection (e.g. encrypted), the type and capabilities of the user computing device (e.g. processor speed, memory, display screen resolution, user input devices, etc.), or the like. The application placement policy document 134 may also specify other dynamic conditions, such as the current network load on the network connection, processing load on the various servers, or the like.

In another embodiment, the application placement policy document 134 also specifies static conditions that are to be considered by the application execution agent 130. These static conditions may include the size of the application program (in the context of application streaming), performance of the application program (in the context of client-side processing power required), graphic-intensity of the user interface (in the context of performance of the application over RDP), or the like. These static conditions may be determined by the administrator personnel when the virtual application package 110 for the application program is created and stored on the virtual application server 108, for example.

Other static conditions that may be specified in the application placement policy document 134 include the business criticality of the application program, priority of the application program (in context of current server load and/or other server-side conditions), role of the current user of the user computing device 102, or the like. It will be appreciated that other dynamic and static conditions may be specified in the application placement policy document 134 that will be considered by the application execution agent 130 in determining the best method for delivering the application program to the user computing device 102 beyond those described herein. It is intended that all such conditions be included in this application. In another embodiment, the application execution agent 130 may further consider factors or conditions outside of the application placement policy document 134, such as a preferred application delivery method specified for the requested application program by the user of the user computing device 102.

Certain factors and/or conditions may prescribe or preclude a particular application delivery method. For example, a business critical application program may only be delivered to the user computing device 102 via remote desktop client 114 when the user computing device is connected outside of the enterprise LAN due to sensitive nature of data retrieved by the application program from internal, secure data sources. Similarly, an application program with a particularly graphically-intensive user interface may not be delivered via remote desktop client 114 because of the poor user experience that would result.

Other conditions may weigh in favor of a particular application delivery method if not prescribed or precluded by other conditions. For example, the application placement policy document 134 may specify that an overloaded condition for the virtual application servers 108 streaming the application program should weigh in favor of selecting the remote desktop application delivery method. Similarly, a preferred application delivery method specified by the user may be utilized to initiate the requested application program if not prevented by other conditions specified in the application placement policy document 134.

It will be appreciated that the application execution agent 130 may be configured to determine the dynamic conditions specified by the application placement policy document 134, such as the current type of network connection of the user computing device 102 or the current load of the virtual application servers 108, by querying application programming interfaces (“APIs”) provided by the user computing device and/or virtual application servers, for example. In one embodiment, the application placement policy server 132 may also determine certain dynamic conditions, like the current load of the virtual application servers 108, remote server computers 118, virtual desktop servers 122, and the like.

According to one embodiment, the application execution agent 130 evaluates the conditions and factors specified in the application placement policy document 134 to determine the best or prescribed application delivery method for the requested application program. In another embodiment, the application execution agent 130 may determine a priority of the available application delivery methods to be utilized, based on the conditions and factors specified by the application placement policy document 134. Upon determining the best or prescribed application delivery method for the requested application program, the routine 200 proceeds from operation 206 to operation 208, where the application execution agent 130 determines whether the application delivery method is currently available to the user computing device 102. For example, the best or prescribed application delivery method determined based on the application placement policy document 134 may not be configured on the user computing device 102, or may not be capable of running within the current user's environment.

If the application execution agent 130 determines that the best application delivery method is available, the routine 200 proceeds from operation 208 to operation 210, where the application execution agent 130 initiates the requested application program using the determined application delivery method. For example, after determining application streaming to be the best method of application delivery for the requested application program, the application execution agent 130 may initiate the requested application program through the virtual application client 104 configured on the user computing device 102. From operation 210, the routine 200 ends.

If, at operation 208, the application execution agent 130 determines that the best application delivery method is not available, the application execution agent may check to see if the next application delivery method in priority order determined based on the application placement policy document 134 is available on the user computing device 102, according to one embodiment. In another embodiment, upon determining that the best or prescribed application delivery method is not available, the routine 200 proceeds to operation 212, where the application execution agent 130 cancels the application execution request and informs the user that the required application delivery method is not available on the user computing device 102. From operation 212, the routine 200 ends.

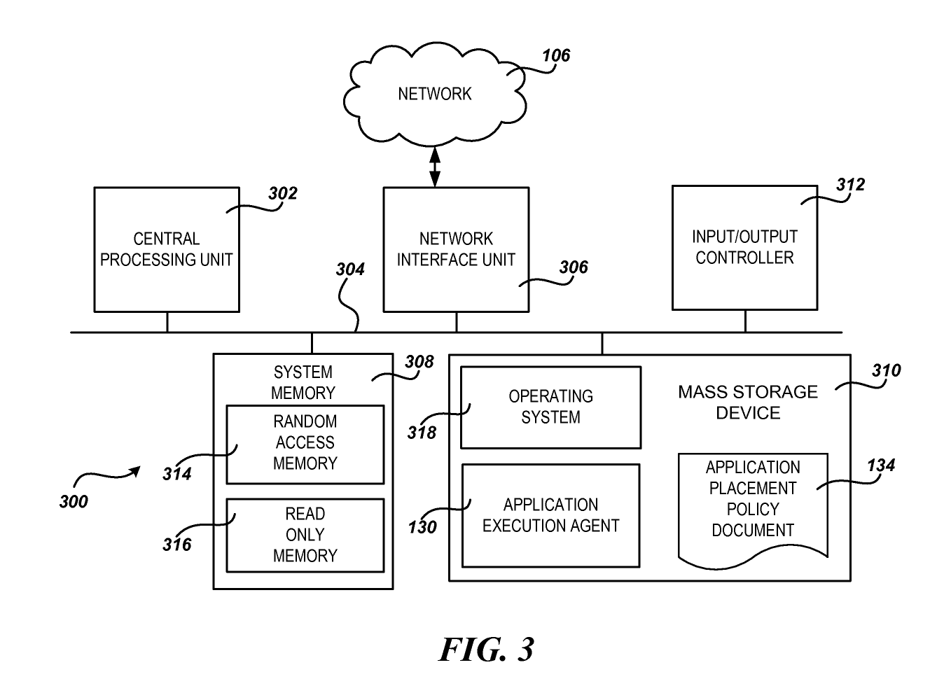

FIG. 3 shows an example computer architecture for a computer 300 capable of executing the software components described herein for automatically selecting a best application delivery method based on a centrally maintained policy, in the manner presented above. The computer architecture shown in FIG. 3 illustrates a conventional server computer, desktop computer, laptop, notebook, PDA, wireless phone, or other computing device, and may be utilized to execute any aspects of the software components presented herein described as executing on the user computing device 102 or other server or computer.

The computer architecture shown in FIG. 3 includes one or more central processing units (“CPUs”) 302. The CPUs 302 may be standard processors that perform the arithmetic and logical operations necessary for the operation of the computer 300. The CPUs 302 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 308, including a random access memory (“RAM”) 314 and a read-only memory 316 (“ROM”), and a system bus 304 that couples the memory to the CPUs 302. A basic input/output system containing the basic routines that help to transfer information between elements within the computer 300, such as during startup, is stored in the ROM 316. The computer 300 also includes a mass storage device 310 for storing an operating system 318, application programs, and other program modules, which are described in greater detail herein.

The mass storage device 310 is connected to the CPUs 302 through a mass storage controller (not shown) connected to the bus 304. The mass storage device 310 provides non-volatile storage for the computer 300. The computer 300 may store information on the mass storage device 310 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 300 may store information to the mass storage device 310 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 300 may further read information from the mass storage device 310 by detecting the physical states or characteristics of one or more particular locations within the mass storage device.

As mentioned briefly above, a number of program modules and data files may be stored in the mass storage device 310 and RAM 314 of the computer 300, including an operating system 318 suitable for controlling the operation of a computer. The mass storage device 310 and RAM 314 may also store one or more program modules. In particular, the mass storage device 310 and the RAM 314 may store the application execution agent 130 and/or the application placement policy document 134, both of which are described in detail above in regard to FIG. 1. The mass storage device 310 and the RAM 314 may also store other types of program modules or data.

In addition to the mass storage device 310 described above, the computer 300 may have access to other computer-readable media to store and retrieve information, such as program modules, data structures, or other data. It should be appreciated by those skilled in the art that computer-readable media can be any available media that may be accessed by the computer 300, including computer-readable storage media and communications media. Communications media includes transitory signals. Computer-readable storage media includes volatile and non-volatile, removable and non-removable media implemented in any method or technology for the storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 300.

The computer-readable storage medium may be encoded with computer-executable instructions that, when loaded into the computer 300, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 300 by specifying how the CPUs 302 transition between states, as described above. According to one embodiment, the computer 300 may have access to computer-readable storage media storing computer-executable instructions that, when executed by the computer, perform the routine 200 for automatically selecting a best application delivery method based on a centrally maintained policy, described above in regard to FIG. 2.

According to various embodiments, the computer 300 may operate in a networked environment using logical connections to remote computing devices and computer systems through the network 106, such as a LAN, a WAN, the Internet, or a network of any topology known in the art. The computer 300 may connect to the network 106 through a network interface unit 306 connected to the bus 304. It should be appreciated that the network interface unit 306 may also be utilized to connect to other types of networks and remote computer systems.

The computer 300 may also include an input/output controller 312 for receiving and processing input from a number of input devices, including a keyboard, a mouse, a touchpad, a touch screen, an electronic stylus, or other type of input device. Similarly, the input/output controller 312 may provide output to a display device, such as a computer monitor, a flat-panel display, a digital projector, a printer, a plotter, or other type of output device. It will be appreciated that the computer 300 not include all of the components shown in FIG. 3, may include other components that are not explicitly shown in FIG. 3, or may utilize an architecture completely different than that shown in FIG. 3.

Based on the foregoing, it should be appreciated that technologies for automatically selecting a best application delivery method based on a centrally maintained policy are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-readable storage medium encoded with computer-executable instructions that, when executed by a computer, cause the computer to:
receive a request to initiate an application program;
request an application placement policy document regarding the application program from an application placement policy server;
receive the application placement policy document from the application placement policy server, wherein the application placement policy document describes a policy for selecting a method for delivery of the application program based on one or more conditions;
determine a method for delivery of the application program to the computer based on the policy described in the application placement policy document and current conditions; and
initiate the application program utilizing the determined method for delivery of the application program.

2. The computer-readable storage medium of claim 1, wherein one or more of the conditions described by the application placement policy document are based on a persona of a current user of the computer.

3. The computer-readable storage medium of claim 1, wherein one or more of the conditions described by the application placement policy document are based on a location or a current networking environment of the computer.

4. The computer-readable storage medium of claim 1, wherein one or more of the conditions described by the application placement policy document are based on capabilities of the computer.

5. The computer-readable storage medium of claim 1, wherein one or more of the conditions described by the application placement policy document are based on static properties of the application program.

6. The computer-readable storage medium of claim 1, wherein the application placement policy server selects the application placement policy document to return in response to the request from among a plurality of centrally maintained application placement policy documents regarding the application program based on a persona of a current user of the computer.

7. The computer-readable storage medium of claim 1, wherein the application program is initiated in such a way that the determined method for delivery of the application program is not made apparent to a user of the user computing device.

8. A computer-implemented method for determining a method for delivery of an application program to a user computing device, the method comprising executing instructions one or more computers to perform the operations of:
receiving a request to initiate the application program;
selecting an application placement policy document from among one or more application placement policy documents regarding the application program based on a persona of a current user of the user computing device;
determining a method for delivery of the application program to the user computing device based on the application placement policy document and current conditions; and
initiating the application program utilizing the determined method for delivery of the application program.

9. The computer-implemented method of claim 8, wherein the application placement policy document describes a policy for determining the method for delivery of the application program based on one or more conditions.

10. The computer-implemented method of claim 9, wherein one or more of the conditions are based on the persona of the current user of the user computing device.

11. The computer-implemented method of claim 9, wherein one or more of the conditions are based on a location or a networking environment of the user computing device.

12. The computer-implemented method of claim 9, wherein one or more of the conditions are based on capabilities of the user computing device.

13. The computer-implemented method of claim 9, wherein one or more of the conditions are based on static properties of the application program.

14. The computer-implemented method of claim 8, wherein the request to initiate the application program is cancelled if the determined method for delivery of the application program is not available on the user computing device.

15. The computer-implemented method of claim 8, wherein the method for delivery of the application program is selected from one of streaming of a virtualized application, executing an instance of the application program in a virtual session, or executing the application in a remote desktop session.

16. The computer-implemented method of claim 8, wherein the application program is initiated in such a way that the determined method for delivery of the application program is not made apparent to the current user of the user computing device.

17. A system for automatically selecting a method for delivery of an application program to a user computing device, the system comprising:
an application execution agent executing on the user computing device and configured to receive a request to initiate the application program;
request an application placement policy document regarding the application program from an application placement policy server;
receive the application placement policy document from the application placement policy server, wherein the application placement policy document describes a policy for selecting the method for delivery of the application program based on one or more conditions;
determine a method for delivery of the application program to the user computing device based on the policy described in the application placement policy document and current conditions; and
initiate the application program utilizing the determined method for delivery of the application program; and
the application placement policy server configured to in response to the request from the application execution agent, select the application placement policy document from among a plurality of centrally maintained application placement policy documents regarding the application program based on a persona of a current user of the user computing device, and
return the selected application placement policy document to the application execution agent.

18. The system of claim 17, wherein the one or more conditions comprises conditions based on one or more of the persona of the current user of the user computing device, a location or networking environment of the user computing device, capabilities of the user computing device, or static properties of the application program.

19. The system of claim 17, wherein the application execution agent is further configured to cancel the request to initiate the application program if the determined method for delivery of the application program is not available on the user computing device.

20. The system of claim 17, wherein the application execution agent initiates the application program in such a way that the determined method for delivery of the application program is not apparent to the current user of the user computing device.
